(19) United States
(12) Patent Application Publication
(10) Pub. No.: US 2019/0098289 A1
(43) Pub. Date: Mar. 28, 2019

(54) ACTIVE 3D SHUTTER-GLASSES OFFERING AN IMPROVED LEVEL OF IMAGE-BRIGHTNESS

(71) Applicant: VOLFONI R&D, Villeneuve-Loubet (FR)

(72) Inventor: Stephen Palmer, Gateshead (GB)

(73) Assignee: VOLFONI R&D, Villeneuve-Loubet (FR)

(21) Appl. No.: 16/137,891

(22) Filed: Sep. 21, 2018

Related U.S. Application Data
(60) Provisional application No. 62/563,744, filed on Sep. 27, 2017.

(51) Int. Cl. H04N 13/341; H04N 13/398; G02C 7/10; G02B 27/22; G02B 27/26; G02F 1/1335; G02F 1/139

(52) U.S. Cl. CPC H04N 13/341; H04N 13/398; G02C 7/101; G02F 1/1393; G02B 27/26; G02F 1/133528; G02B 27/2264

(57) ABSTRACT

The present invention discloses the design of active 3d shutter-glasses for the viewing of time-multiplexed stereoscopic three dimensional (3d) images that offer both an improved level of on-screen image-brightness as well as reduced manufacturing costs as compared to other prior-art technologies. The disclosed invention is based on the insight that a tangential in-plane electrical-field can be utilized in order to provide for a voltage-assisted relaxation switching step together with cholesteric liquid crystal materials, thereby increasing the relaxation speed of said cholesteric liquid crystal materials thereof. Furthermore, dichroic-dye materials can additionally be added to said cholesteric liquid crystal materials in order to absorb at least some of the scattered light and hence reduce the overall level of perceived on-screen image-haze.

### CROSS-REFERENCE TO RELATED APPLICATION

This application claims the benefit of priority to U.S. Provisional Application No. 62/563,744, filed Sep. 27, 2017, which is incorporated herein by reference.

### FIELD OF INVENTION

The present invention relates to the design of active 3d shutter-glasses for the viewing of time-multiplexed stereoscopic three dimensional (3d) images offering an improved level of on-screen image-brightness, and more specifically to the design of active 3d shutter-glasses based on cholesteric liquid crystal optical-shutters that are modulated between at least two different optical states.

### BACKGROUND OF THE INVENTION

There are a number of different technologies known to the art for the creation of time-multiplexed stereoscopic 3d images. One technology known to the art and described, for example, in U.S. Pat. No. 5,463,428 dated 31 Oct. 1995 and entitled “Wireless active eyewear for stereoscopic applications”, utilizes active 3d shutter-glasses. Here, the image generated by a digital cinema projector such as a DLP-projector or otherwise is arranged so as to comprise a rapid succession of alternate left and right-eye images at high frequencies of typically 144 Hz (hertz). 3D shutter-glasses are then used to sequentially block and transmit said left and right-eye images in synchronization with said projector in order to ensure said left and right eye images are individually channeled to the left and right eyes respectively, thereby enabling time-multiplexed stereoscopic 3d images to be viewed on the surface of a projection-screen typically located some distance away.

Furthermore, it is known to one skilled-in-the-art that a number of different technologies can be used when designing the lenses composing said active 3d shutter-glasses. One technology known to the art and described, for example, in U.S. Pat. No. 4,884,876 dated 5 Dec. 1989 and entitled “Achromatic liquid crystal shutter for stereoscopic and other applications”, uses optical-shutters comprising of liquid crystal materials. Here, said liquid crystal materials are bound in-between two mutually parallel substrates located a small distance apart in order to form a liquid crystal cell. The distance between said substrates is referred to as being the cell-gap and typically lies in the interval between approximately 2.5 μm (micrometers) and 15 μm, respectively.

Furthermore, the inner-surfaces of each of said substrates are typically coated with an optically transparent and electrically conductive layer such as tin-doped indium oxide (ITO) or otherwise in order to provide for electrodes, thereby enabling externally generated voltage-signals to be applied to said liquid crystal materials thereof. Moreover, an additional alignment coating such as uniaxially rubbed polyimide or otherwise may be used to coat the surface of each of said electrodes in order to generate the required liquid crystal surface molecular alignment directors and hence ensure the correct operation of said liquid crystal optical-shutter according to the state-of-the-art.

When a first voltage-signal is applied to said liquid crystal materials according to the prior-art, said liquid crystal materials are typically switched to a first optical state; application of a second voltage-signal thereafter which may or may not be zero volts, typically switches said liquid crystal materials to a second optical state thereto, with said first and second optical states being mutually different. Furthermore, by arranging for said first optical state to be substantially transparent (i.e. open) and said second optical state to be substantially opaque (i.e. closed), then said liquid crystal optical-shutter can be rapidly modulated between an open and closed state via application of suitable externally generated voltage-signals.

Moreover, it will be known to one skilled-in-the-art that said liquid crystal materials may preferentially comprise of twisted-nematic (TN) liquid crystal materials. Here, said twisted-nematic liquid crystal materials may, for example, be modulated between a homogeneous (e.g. un-powered) texture and a homeotropic (e.g. powered) texture respectively upon application of suitable voltage-signals. The homogeneous texture is characterized by the molecular-axes of said twisted-nematic liquid crystal materials being aligned substantially parallel with the inner-surfaces of said substrates, whereas the homeotropic texture is characterized by said molecular-axes for said twisted-nematic liquid crystal materials being aligned substantially perpendicular to said inner-surfaces of said substrates thereof.

Furthermore, by placing said liquid crystal cell comprising said twisted-nematic liquid crystal materials in-between mutually perpendicular linear polarization-filters, it can be arranged such that when said twisted-nematic liquid crystal materials are switched to said homogeneous texture, then said optical-shutter is in an optical state that possesses a high level of optical transmission (i.e. open). Moreover, when said twisted-nematic liquid crystal materials are instead switched to said homeotropic texture, then said optical-shutter will in such case be in an optical state that possesses a low level of optical transmission (i.e. closed). The aforementioned twisted-nematic liquid crystal cell according to the state-of-the-art can hence be rapidly modulated between an open and closed state via application of suitable externally generated voltage-signals and is therefore typically used for applications such as active 3d shutter-glasses.

However, it will be understood by one skilled-in-the-art that since the images generated by a typical DLP-projector or other display systems are typically randomly polarized (i.e. unpolarized), then the utilization of a linear polarization-filter placed on the front-surface of the lenses composing said 3d shutter-glasses will limit the maximum theoretical optical transmission when in the open state to only 50%. In practice, this value may be typically less than 40% due to the occurrence of surface reflections and other optical losses and hence results in the generation of time-multiplexed stereoscopic 3d images that are severely lacking in on-screen image brightness.

In order to improve the overall brightness of a stereoscopic 3d image when utilizing a DLP-projector or other display system that generates images that are initially randomly polarized, it will be known to one skilled-in-the-art that active 3d shutter-glasses are required that do not necessitate the utilization of optical polarization-filters.

One technology known to the art that fulfils this criterion and described, for example, in U.S. Pat. No. 5,691,795 dated 25 Nov. 1997 and entitled “Polymer stabilized liquid crystalline light modulating device and material”, is the Polymer Stabilized Cholesteric Textured (PSCT) liquid crystal technology. Here, nematic type liquid crystal materials are typically doped with a chiral additive in order to provide a cholesteric liquid crystal material that forms a natural spontaneous helical-twisting structure in the absence of an electrical-field or other externally imposed boundary conditions. The pitch of said cholesteric liquid crystal materials is defined as being the distance through which said helical-twisting structure rotates by 360 degrees and is an intrinsic property of said cholesteric liquid crystal materials thereof. It will also be known to one skilled-in-the-art that the pitch of said cholesteric liquid crystal materials is a reciprocal function of the chiral concentration, and increasing the concentration of said chiral additive will result in there being a corresponding reduction in the pitch of said cholesteric liquid crystal materials thereof and vice versa.

A polymer-network is thereafter created within said cholesteric liquid crystal materials according to the state-of-the-art by, for example, first dissolving a small quantity of reactive-monomer together with a photo-initiator into said cholesteric liquid crystal materials; the reactive-monomer is thereafter photo-polymerized via irradiation with Ultra-Violet (UV) light or otherwise in order to create a solid polymer-network that extends throughout the bulk of the layer of said cholesteric liquid crystal materials thereof.

The polymer-network created within said cholesteric liquid crystal materials stabilizes the focal-conic texture (i.e. un-powered state) and also enhances the transition speed of said cholesteric liquid crystal materials when undergoing spontaneous relaxation from the homeotropic (i.e. powered state) to said focal-conic texture thereof. The focal-conic texture is characterized by said cholesteric liquid crystal materials forming a poly-domain structure; within the volume of each individual domain region said cholesteric liquid crystal materials form a uniformly aligned and predominantly homogeneous helical-structure, but the orientation of said helical-structure is different for each of said individual domain regions. There therefore exists a domain-boundary between neighboring domain regions characterized by there being an abrupt change in the refractive-index of said cholesteric liquid crystal materials and light passing through said focal-conic texture will therefore undergo scattering in the vicinity of said domain-boundary regions. The focal-conic texture therefore generates a high level of light scattering.

The homeotropic texture is characterized by said cholesteric liquid crystal materials being uniformly aligned with their molecular-axes being substantially perpendicular to the inner-surfaces of said substrates and in such case light will then pass through said cholesteric liquid crystal materials without undergoing scattering or other optical attenuation processes. It will also be known to one skilled-in-the-art that should said cholesteric liquid crystal materials additionally possess a positive dielectric anisotropy (As), then a suitable high voltage-signal with electrical-field vector aligned perpendicular to the inner-surfaces of said substrates will in such case be able to switch said cholesteric liquid crystal materials to said homeotropic texture thereof.

Therefore, when in the focal-conic texture said polymer stabilized cholesteric textured liquid crystal materials possess a high level of optical opacity and hence appear to be cloudy or milky-white, whereas when in the homeotropic texture said cholesteric liquid crystal materials possess a high level of optical transmission that typically exceeds 85% over the visible wavelength region. Furthermore, the transition speed when switching between said textures is typically less than one millisecond (ms), thereby enabling active 3d shutter-glasses to be developed according to the state-of-the-art that offer both a high level of on-screen image-brightness together with a high frequency of modulation.

However, the process steps required to manufacture said polymer stabilized cholesteric textured liquid crystal optical-shutters are rather complex since an additional photo-polymerization step is required as compared to standard liquid crystal display (LCD) manufacturing processes. Furthermore, the polymer-network often fractures or degrades when said polymer stabilized cholesteric textured liquid crystal optical-shutters are operated over extended periods of time, thereby leading to the premature failure of the device.

Additionally, when in the focal-conic texture said polymer stabilized cholesteric textured liquid crystal materials form a light-scattering state that appears to be cloudy or milky-white; whilst said light-scattering state is capable of blocking the unwanted left and right-eye images when being used in active 3d shutter-glasses, light from the blocked image will nevertheless still be scattered over a wide range of viewing angles, resulting in the generation of a high level of image-haze that makes the overall stereoscopic 3d image appear to have a low level of optical contrast, hence appearing to be somewhat faded or washed-out.

Moreover, the magnitude of the voltage-signals required to switch said polymer stabilized cholesteric textured liquid crystal optical-shutters to said homeotropic texture are typically in excess of 10 volts per micrometer (V/μm), thereby resulting in the necessity of utilizing high voltage-signals often in excess of 80 volt when using a typical cell-gap of 8.0 micrometers (m) according to the state-of-the-art. This not only significantly increases the power-consumption of the device and thereby reducing the lifetime of any battery used to power the system, but also provides a significant safety risk when used in active 3d shutter-glasses that are placed in close proximity to the viewer's eyes.

An alternative technology known to the art that also fulfils the criterion of not requiring the utilization of polarization-filters and described, for example, in U.S. Pat. No. 5,453,863 dated 26 Sep. 1995 and entitled “Multistable chiral nematic displays”, is the Surface Stabilized Cholesteric Textured (SSCT) liquid crystal technology. Here, cholesteric liquid crystal materials are once again bound in-between two mutually parallel substrates, but in this case the inner-surfaces of both substrates are each typically coated with a suitable homeotropic aligning polyimide layer (i.e. vertical alignment) in order to stabilize both the focal-conic and planar textures without the necessity of incorporating an additional polymer-network within said cholesteric liquid crystal materials. The planar texture is characterized by the molecular-axes of said cholesteric liquid crystal materials being uniformly aligned in a direction substantially parallel with the inner-surfaces of said substrates. However, when using surface stabilized cholesteric textured liquid crystal materials, the switching speeds between said optical states is typically in excess of several tens of milliseconds (ms) and hence the surface stabilized cholesteric textured liquid crystal technology according to the state-of-the-art is too slow for use in applications such as active 3d shutter-glasses that are required to be modulated at high frequencies of typically 144 Hz.

An object of the present invention is to provide active 3d shutter-glasses that offer both a higher level of on-screen image brightness together with a reduction of image-haze as compared to other prior-art technologies. A further object of the present invention is to provide active 3d shutter-glasses that can be economically manufactured using existing standard Twisted Nematic Liquid Crystal Display (TN-LCD) type manufacturing processes and which operate with low voltage as well as offering a higher level of lifetime durability.

### SUMMARY OF THE INVENTION

The disclosed invention is based on the insight that when a suitable voltage-signal is applied to a cholesteric liquid crystal material, said liquid crystal materials can be initially switched to a focal-conic texture possessing a high level of optical opacity corresponding to a first optical state. However, in the absence of a polymer-network or other boundary conditions, said first optical state is only stable for a relatively short period of time typically less than approximately 20 ms (milliseconds) and thereafter said cholesteric liquid crystal materials start to spontaneously switch to a second optical state thereto, wherein said second optical state possesses a lower level of optical opacity.

However, this relatively short period of stability is nevertheless still sufficient for applications such as active 3d shutter-glasses where said cholesteric liquid crystal materials are required to be continuously modulated between said first and second optical states thereof at high frequencies of typically 144 Hz; this corresponds to the situation where said cholesteric liquid crystal materials are only required to reside in each of said first and second optical states thereof for a time period of typically less than approximately 6.9 ms, and this time period is less than the time duration before which said focal-conic texture starts to spontaneously decay.

Moreover, the present invention is further based on the insight that by the appropriate patterning of the electrode on the inner-surface of at least one of said substrates composing said cholesteric liquid crystal optical-shutter, a suitable voltage-signal can be utilized in order to generate an in-plane tangential electrical-field within said cholesteric liquid crystal materials and which enhances the relaxation speed of said cholesteric liquid crystal materials when switching from said homeotropic to said focal-conic texture thereof. The relaxation speed for said cholesteric liquid crystal materials is thereby increased due to the presence of said tangential electrical-field and this therefore enables a fast optical-shutter to be developed according to the present invention for applications such as active 3d shutter-glasses that offer both a higher level of image brightness as well as requiring a lower operating voltage as compared to other prior-art technologies.

A further object of the present invention is that by adding a small concentration of dichroic-dye material to said cholesteric liquid crystal materials, then at least some of the scattered-light will in such case be absorbed when said cholesteric liquid crystal materials are switched to said focal-conic texture, thereby significantly reducing the level of perceived on-screen image-haze when viewing time-multiplexed stereoscopic 3d images on the surface of a projection-screen.

This enables active 3d shutter-glasses to be designed according to the present invention for the viewing of time-multiplexed stereoscopic 3d images that offer both a high level of on-screen image brightness and which can be economically manufactured using standard TN-LCD type manufacturing processes. Furthermore, the elimination of the necessity of incorporating a polymer-network within said cholesteric liquid crystal materials significantly improves the lifetime stability of the product. Additionally the utilization of dichroic-dye materials reduces the level of perceived on-screen image-haze.

In one aspect the invention features active 3d shutter-glasses for the viewing of time-multiplexed stereoscopic 3d images comprising a first lens and a second lens, with each of said lenses including at least one optical-shutter having a first substrate and a second substrate with cholesteric liquid crystal material being bound in-between said first and second substrates. The optical shutter including a first electrode on an inner-surface of the first substrate and a second electrode on an inner-surface of the second substrate. The first electrode is patterned to form a plurality of mutually parallel electrode-lines, with all odd-numbered electrode-lines being electrically connected together in parallel to form a first electrode-patterning, and with all even-numbered electrode-lines being electrically connected together in parallel to form a second electrode-patterning. The active 3d shutter glasses are configured to receive a first externally generated voltage-signal with a magnitude exceeding a threshold-voltage for said cholesteric liquid crystal material applied between said first electrode and said second electrode in order to generate an electrical-field within said cholesteric liquid crystal material with an electrical-field vector being aligned substantially perpendicular to the inner surfaces of said substrates in order to switch said cholesteric liquid crystal material to a homeotropic texture corresponding to a first optical state possessing a high level of optical transmission. The active 3d shutter glasses are further configured to receive a second externally generated voltage-signal being applied between said first electrode-patterning and said second electrode-patterning of said first electrode in order to generate an in-plane electrical-field within said cholesteric liquid crystal material with an electrical-field vector being aligned substantially parallel with the inner surfaces of said substrates in order to provide for a voltage-assisted relaxation switching step when said cholesteric liquid crystal material switch from said homeotropic texture to the focal-conic texture corresponding to a second optical state thereof, and with said second optical state possessing a relatively low level of optical transmission. Each optical-shutter is configured to be modulated between said first and second optical states in synchronization with images generated by an external display system in order to generate a time-multiplexed three dimensional (3d) image.

In some embodiments, the odd-numbered electrode-lines are electrically connected together along a first edge of said first substrate. In some embodiments, the even-numbered electrode-lines are electrically connected together along a second edge of said first substrate, with said first and second edges being located on predominantly mutually opposite sides of said first substrate. In some embodiments, each of said electrode-lines of said first and second electrode-patternings have widths between 5 micrometers and 500 micrometers. In some embodiments, each of said electrode-lines of said first and second electrode-patternings have widths between 20 micrometers and 200 micrometers. In some embodiments, each of said electrode-lines of said first and second electrode-patternings are spaced from adjacent electrode lines by a gap between 1.0 micrometer and 200 micrometers. In some embodiments, each of said electrode-lines of said first and second electrode-patternings are spaced from adjacent electrode lines by a gap between 5 micrometers and 50 micrometers. In some embodiments, the length of each of said electrode-lines of said first and second electrode-pattemings is between 5 millimeters and 500 millimeters.

In some embodiments, the length of each of said electrode-lines of said first and second electrode-patternings is between 20 millimeters and 50 millimeters. In some embodiments, the distance between said first and second substrates of the at least one optical shutter of each lens is between 2.5 micrometers and 30 micrometers. In some embodiments, the distance between said first and second substrates of the at least one optical shutter of each lens is between 4.0 micrometers and 20 micrometers. In some embodiments, at least one of said first and second electrodes comprises a transparent electrically conducting layer with electrical resistance being between 1.0 ohm per square and 800 ohms per square. In some embodiments, at least one of said first and second electrodes comprises a transparent electrically conducting layer with electrical resistance being between 10 ohms per square and 200 ohms per square. In some embodiments, the cholesteric liquid crystal material comprises a dichroic-dye material with concentration between 0.1% (by weight) and 10% (by weight). In some embodiments, the cholesteric liquid crystal material comprises a dichroic-dye material with concentration between 0.5% (by weight) and 5.0% (by weight). In some embodiments, the second electrode is patterned to form a plurality of mutually parallel electrode-lines, with all odd-numbered electrode-lines being electrically connected together in parallel to form a third electrode-patterning, and with all even-numbered electrode-lines being electrically connected together in parallel to form a fourth electrode-patterning. In some embodiments, the electrode-lines of said first and second electrode-patternings are aligned substantially perpendicular to said electrode-lines of said third and fourth electrode-pattemings. In some embodiments, the electrode-lines of said first and second electrode-pattemings are aligned substantially parallel with said electrode-lines of said third and fourth electrode-patternings. In some embodiments, at least one optical shutter of at least one of said first and second lenses comprises a stack of at least two optical-shutters each configured according to claim 1.

In another aspect, the invention features active 3d shutter-glasses for the viewing of time-multiplexed stereoscopic 3d images. The active 3d shutter-glasses include a first lens and a second lens, each of said lenses including at least one optical-shutter. The at least one optical shutter includes a first substrate and a second substrate with cholesteric liquid crystal material being bound in-between said first and second substrates. The at least one optical shutter also includes a first electrode on an inner-surface of said first substrate and a second electrode on an inner-surface of said second substrate. The first electrode is patterned to form a plurality of mutually parallel electrode-lines, with all odd-numbered electrode-lines being electrically connected together in parallel to form a first electrode-patterning, and with all even-numbered electrode-lines being electrically connected together in parallel to form a second electrode-patterning.

In some embodiments, the active 3d shutter-glasses are configured to receive a first externally generated voltage-signal with a magnitude exceeding a threshold-voltage for said cholesteric liquid crystal material applied between said first electrode and said second electrode in order to generate an electrical-field within said cholesteric liquid crystal materials with an electrical-field vector being aligned substantially perpendicular to the inner surfaces of said substrates in order to switch said cholesteric liquid crystal material to a homeotropic texture corresponding to a first optical state possessing a high level of optical transmission. In some embodiments, the active 3d shutter glasses are configured to receive a second externally generated voltage-signal being applied between said first electrode-patterning and said second electrode-patterning of said first electrode in order to generate an in-plane electrical-field within said cholesteric liquid crystal material with an electrical-field vector being aligned substantially parallel with the inner surfaces of said substrates in order to provide for a voltage-assisted relaxation switching step when said cholesteric liquid crystal material switch from said homeotropic texture to the focal-conic texture corresponding to a second optical state thereof, and with said second optical state possessing a relatively low level of optical transmission. In some embodiments, each said optical-shutter is configured to be modulated between said first and second optical states in synchronization with images generated by an external display system in order to generate a time-multiplexed three dimensional (3d) image.

### BRIEF DESCRIPTION OF THE FIGURES

The present invention may be better understood and its objects and advantages will become apparent to one skilled-in-the-art by reference to the accompanying drawings, wherein like reference numerals refer to like elements in several of the figures.

FIG. 1: A pair of active 3d shutter-glasses according to the state-of-the-art.

FIG. 2: Detailed design of a Twisted-Nematic (TN) liquid crystal optical-shutter according to the state-of-the-art.

FIG. 3: Detailed design of a Polymer Stabilized Cholesteric Textured (PSCT) liquid crystal optical-shutter according to the state-of-the-art.

FIG. 4: Detailed design of a cholesteric liquid crystal optical-shutter according to a first preferred embodiment of the present invention.

FIG. 5: Detailed illustration of the operation of a cholesteric liquid crystal optical-shutter according to a first aspect of the present invention.

FIG. 6: Detailed illustration of the operation of a cholesteric liquid crystal optical-shutter according to a second aspect of the present invention.

FIG. 7: Detailed design of a cholesteric liquid crystal optical-shutter according to a second preferred embodiment of the present invention.

FIG. 8: Detailed design of a cholesteric liquid crystal optical-shutter according to a third preferred embodiment of the present invention.

FIG. 9: Two separate and individual cholesteric liquid crystal optical-shutters stacked together according to a further preferred embodiment of the present invention.

### DETAILED DESCRIPTION OF THE INVENTION

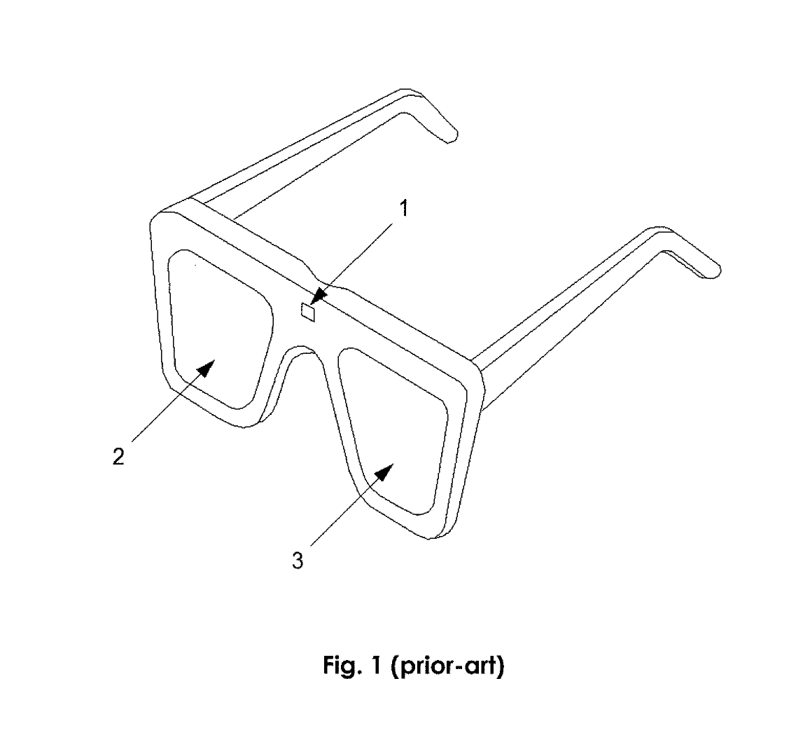

FIG. 1 shows a pair of active 3d shutter-glasses according to the state-of-the-art. Here, the two lenses 2, 3 composing said shutter-glasses each comprise of liquid crystal optical-shutters and a synchronization system 1 is provided in order to synchronize the modulation of said lenses together with the images generated by a digital cinema projector (not shown) such as a DLP-projector or otherwise. The synchronization system I may for example comprise a Radio Frequency (RF) detector or otherwise. This enables the viewer to observe time-multiplexed stereoscopic 3d images on the surface of a projection-screen (not shown) typically located some distance away.

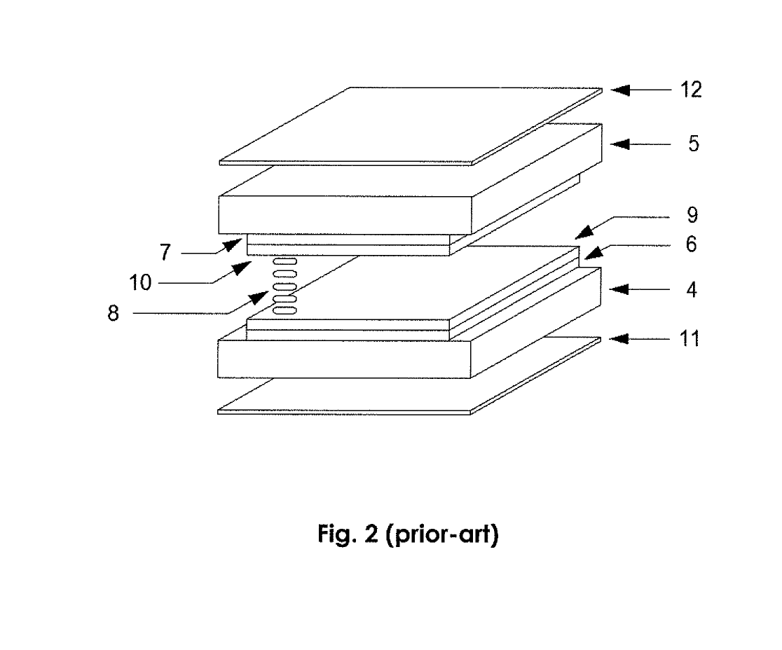

The lenses 2, 3 composing said active 3d shutter-glasses according to the state-of-the-art typically each comprise of Twisted-Nematic (TN) liquid crystal optical-shutters. FIG. 2 shows the typical design of said twisted-nematic liquid crystal optical-shutters according to the state-of-the-art. Here, said twisted-nematic liquid crystal materials 8 are bound in-between two mutually parallel substrates 4, 5 respectively, such as flat glass-plates or otherwise. The distance between said substrates is defined as being the cell-gap and typically lies in the interval between approximately 2.5 μm (micrometers) and 15 μmm, respectively.

The inner-surfaces of each of said substrates 4, 5 are typically coated with a transparent electrically conducting layer such as tin-doped indium oxide (ITO) or otherwise in order to provide for electrodes 6, 7 thereof. Additionally, the surface of each of said electrodes 6, 7 may preferentially also be coated with an alignment layer 9, 10 respectively, such as uniaxially rubbed polyimide or otherwise, in order to provide the required liquid crystal surface molecular alignment directors (not shown) on the inner-surfaces of said substrates 4, 5 thereto and hence ensure the correct operation of said twisted-nematic liquid crystal optical-shutter according to the state-of-the-art.

When a suitable externally generated voltage-signal (not shown) is applied between said electrodes 6, 7 thereof, an electrical-field (not shown) is generated within said twisted-nematic liquid crystal materials 8 with an electrical-field vector oriented in a direction substantially perpendicular to the inner-surfaces of said substrates 4, 5 thereto. Furthermore, if said twisted-nematic liquid crystal materials 8 additionally possess a positive dielectric anisotropy (Δε), then said perpendicular electrical-field can be arranged so as to switch said twisted-nematic liquid crystal materials 8 to the homeotropic texture. Moreover, if instead no voltage is applied between said electrodes 6, 7 thereof, then in such case said twisted-nematic liquid crystal materials 8 may for example be arranged so as to undergo relaxation in order to switch to the homogeneous texture.

It will be known to one skilled-in-the-art that in general there are two different switching speeds associated with twisted-nematic liquid crystal materials, namely (i) the activation switching speed when a suitable voltage-signal is applied to said twisted-nematic liquid crystal materials and results in said liquid crystal materials undergoing an activated switching step to a first powered state, and (ii) the relaxation switching speed when the voltage is removed from said twisted-nematic liquid crystal materials enabling said liquid crystal materials to undergo a spontaneous relaxation back to a second un-powered state thereto. Furthermore, since the activation switching speed is a function of the magnitude of the applied voltage-signal, then high voltage-signal spikes can be used in order to obtain very fast activation switching speeds. However, the relaxation switching speed is not affected by the magnitude of the voltage-signal and is therefore in general significantly slower than said activation switching speed.

Furthermore, according to the state-of-the-art said twisted-nematic liquid crystal optical-shutter may, for example, be preferentially placed in-between two mutually perpendicular polarization-filters 11, 12 respectively. In such case, when said twisted-nematic liquid crystal materials 8 are switched to said homeotropic texture, then said optical-shutter can be arranged to be in a first optical-state possessing a low level of optical transmission (i.e. closed). Moreover, when said twisted-nematic liquid crystal materials 8 are instead switched to said homogeneous texture, then said optical-shutter can be arranged to switch to a second optical state possessing a higher level of optical transmission (i.e. open). This therefore enables said twisted-nematic liquid crystal optical-shutter to be rapidly modulated between said open and closed states via application of suitable voltage-signals according to the state-of-the-art.

However, it will be understood by one skilled-in-the-art that since optical polarization-filters 11, 12 are required in order for said twisted-nematic liquid crystal optical-shutter to correctly operate, then if the image generated by a display system such as a DLP-projector or otherwise is initially randomly polarized, then the theoretical maximum optical transmission for said twisted-nematic liquid crystal optical-shutters when in said open state will in such case be limited to only 50%. In practice, this figure may be reduced to typically below approximately 40% due to the occurrence of surface reflections and other optical losses and hence results in the generation of a time-multiplexed stereoscopic 3d image that is severely lacking in on-screen image brightness when utilizing said twisted-nematic liquid crystal technology according to the state-of-the-art.

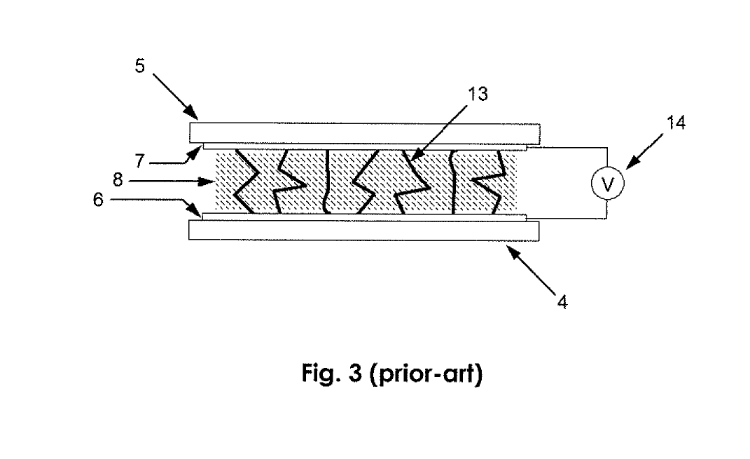

It will be understood by one skilled-in-the-art that in order to increase the on-screen image brightness when utilizing active 3d shutter-glasses to generate a time-multiplexed stereoscopic 3d image, the necessity of utilizing optical polarization-filters should preferably be eliminated. One technology known to the art that fulfils this criterion and shown in FIG. 3 is the Polymer Stabilized Cholesteric Textured (PSCT) liquid crystal technology. Here, cholesteric liquid crystal materials 8 are bounded in-between two mutually parallel substrates 4, 5 respectively and a polymer-network 13 is created within the layer of said cholesteric liquid crystal materials by first dissolving a small quantity of reactive-monomer (not shown) and photo-initiator (not shown) within said cholesteric liquid crystal materials and then photo-polymerizing said reactive-monomer thereafter via irradiation with Ultra-Violet (UV) light or otherwise.

Furthermore, the inner-surfaces of said substrates 4, 5 are each coated with a transparent electrically conducting layer such as indium-doped tin oxide (ITO) or otherwise in order to provide for electrodes 6, 7 thereof, and the surface of each of said electrodes 6, 7 may additionally be coated with a suitable alignment layer (not shown) such as polyimide or otherwise in order to generate the desired surface molecular alignment directors (not shown) and hence ensure the correct operation of said polymer-stabilized cholesteric textured liquid crystal optical-shutter according to the state-of-the-art.

When suitable externally generated high voltage-signals 14 are applied between said electrodes 6, 7 covering the inner-surfaces of said substrates 4, 5 thereof, an electrical-field (not shown) is generated within said cholesteric liquid crystal materials 8 with an electrical-field vector aligned in a direction substantially perpendicular to the inner-surfaces of said substrates 4, 5 thereof. Furthermore, if said cholesteric liquid crystal materials 8 additionally possess a positive dielectric anisotropy (As), then said perpendicular electrical-field may in such case be arranged to switch said cholesteric liquid crystal materials 8 to the homeotropic texture, corresponding to a first optical state possessing a high level of optical transmission (i.e. open). In order for said perpendicular electrical-field to be able to switch said cholesteric liquid crystal materials 8 to said homeotropic texture, it will be known to one skilled-in-the-art that the magnitude of the voltage-signal 14 applied between said electrodes 6, 7 thereof is required to exceed the threshold voltage for said cholesteric liquid crystal materials 8. The threshold voltage is defined as being the voltage at which said cholesteric liquid crystal materials 8 start to switch to said homeotropic texture and is dependent upon the intrinsic parameters of said cholesteric liquid crystal materials, such as but not limited to the dielectric anisotropy (Δε), surface anchoring energy as well as the cell-gap (d).

Moreover, if instead zero volts is applied between said electrodes 6, 7 thereof, then said cholesteric liquid crystal materials 8 will in such case undergo relaxation to form the focal-conic texture, corresponding to a second optical state possessing a high level of optical opacity (i.e. closed). The polymer-network 13 stabilizes said focal-conic texture and also enhances the switching speed when said cholesteric liquid crystal materials 8 undergo relaxation from said homeotropic texture to said focal-conic texture thereto. In such way, said polymer-stabilized cholesteric textured liquid crystal optical-shutters according to the state-of-the-art can be rapidly modulated between said open and closed states in response to an externally generated voltage-signal and hence can be used in applications such as active 3d shutter-glasses.

However, the manufacturing steps required to create said polymer-network 13 within said cholesteric liquid crystal materials 8 are relatively complex and furthermore said polymer-network 13 tends to fracture and degrade when said 3d shutter-glasses are operated over extended periods of time, thereby leading to the possible premature failure of the device. Moreover, the presence of said polymer-network 13 within the layer of said cholesteric liquid crystal materials 8, results in the generation of a small residual amount of light-scattering when said cholesteric liquid crystal materials 8 are switched to said homeotropic texture, hence reducing the overall optical transmission of the open state and reducing the perceived level of image brightness when viewing time-multiplexed stereoscopic 3d images according to the state-of-the-art.

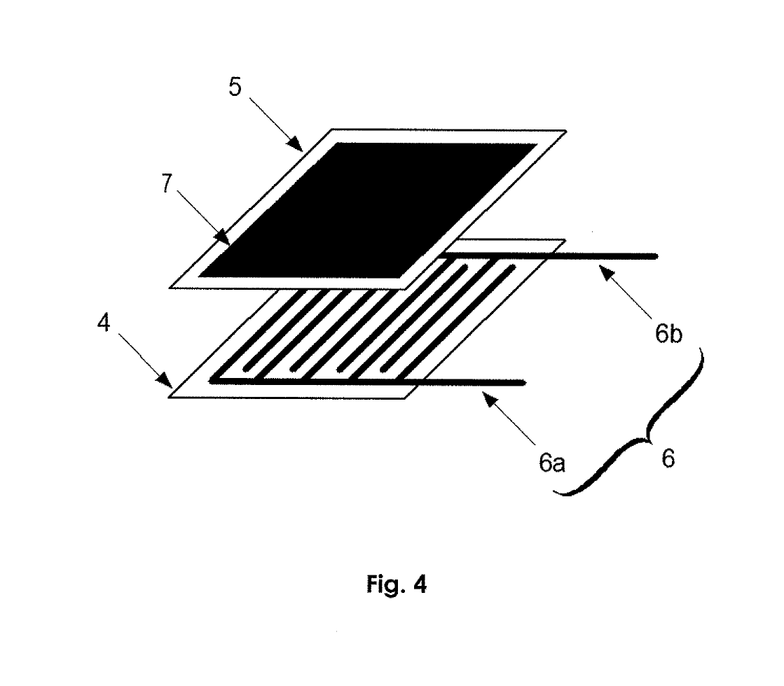

FIG. 4 shows a preferred embodiment of the present invention disclosed herein. Here, cholesteric liquid crystal materials (not shown) are bound in-between two mutually parallel substrates 4, 5 thereof located a small distance apart and the inner-surface of each of said substrates 4, 5 are coated with a transparent electrically conducting layer such as tin-doped indium oxide (ITO) or otherwise in order to provide for electrodes 6, 7 thereto. The electrical sheet-resistance of said transparent electrically conducting layer is preferably in the interval of 1.0 ohm/square (ohms per square) and 800 ohms/square, and more preferably in the interval of 10 ohms/square and 200 ohms/square, respectively. Other transparent coatings that are also electrically conducting such as but not limited to organic polymers, transparent conducting oxides (TCO), thin metallic coatings or nanowires may also be used to create said electrodes 6, 7 thereto without departing from the inventive idea disclosed herein.

The distance between said mutually parallel substrates 4, 5 is defined as being the cell-gap and preferably lies in the interval between 2.5 micrometers (μm) and 30 micrometers, and more preferably in the interval between 4.0 micrometers and 20 micrometers, respectively.

Furthermore, it is disclosed according to the present invention that at least the first electrode 6 on the inner-surface of said first substrate 4 is patterned to form a plurality of individual and mutually parallel electrode-lines, with all odd-numbered electrode-lines preferably being electrically connected together in parallel along a first edge of said first substrate 4 to form a first electrode-patterning 6a, and with all even-numbered electrode-lines preferably being electrically connected together in parallel along a second edge of said first substrate 4 to form a second electrode-patterning 6b, with said first and second electrode-patternings 6a, 6b both being formed on the inner-surface of the same said first substrate 4, and with said first and second edges of said first substrate 4 being located on substantially opposite sides of said first substrate 4 thereto. This results in there being provided an inter-digitalized electrode patterning 6 comprising a first and second electrode-patterning 6a, 6b respectively and located on the inner-surface of said first substrate 4 thereof.

The individual widths of each of said electrode-lines composing each of said electrode-patternings 6a, 6b respectively and which further compose said first electrode 6 thereof, are preferably in the interval between 5 micrometers (m) and 500 micrometers, and more preferably in the interval between 20 micrometers and 200 micrometers, respectively, Moreover, the gap or distance in-between neighboring electrode-lines composing said electrode 6, are preferably in the interval between 1.0 micrometer and 200 micrometers, and more preferably in the interval between 5 micrometers and 50 micrometers, respectively. Furthermore, the lengths of each of said electrode-lines composing each of said electrode-patternings 6a, 6b respectively, are preferably in the interval between 5 millimeters (mm) and 500 millimeters, and more preferably in the interval between 20 millimeters and 50 millimeters, respectively.

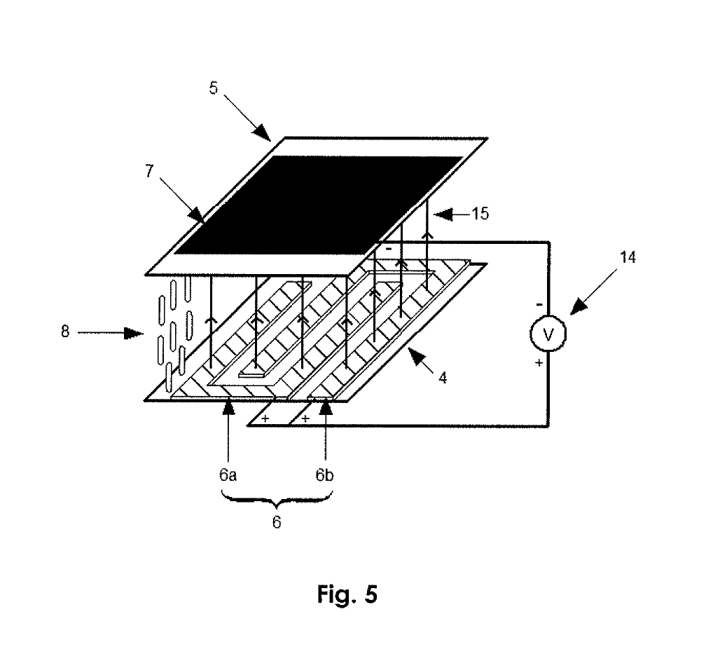

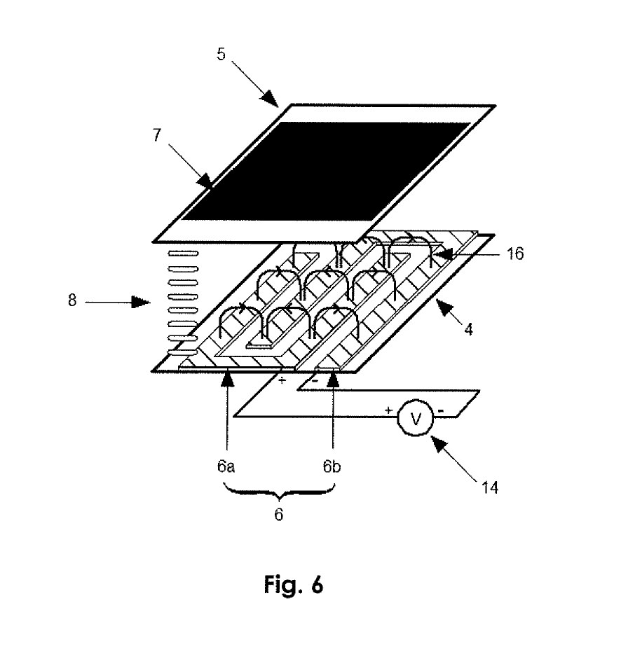

The detailed workings of the disclosed invention are further described and illustrated with reference to both FIG. 5 and FIG. 6 respectively. Specifically, with reference first to FIG. 5, when a suitable externally generated high voltage-signal 14 is applied between said first electrode 6 comprising of both said electrode-patternings 6a, 6b respectively located on the inner-surface of said first substrate 4, and said second electrode 7 on the inner-surface of said second substrate 5, then a perpendicular electrical-field 15 is generated within said cholesteric liquid crystal materials 8 with an electrical-field vector being substantially aligned in a direction perpendicular to the inner-surfaces of said substrates 4, 5 thereof.

Additionally, if said cholesteric liquid crystal materials 8 furthermore possess a positive dielectric anisotropy (Δε), then said perpendicular electrical-field 15 can be arranged to switch said cholesteric liquid crystal materials 8 to said homeotropic texture, corresponding to a first optical state possessing a high level of optical transmission (i.e. open). In order for said electrical-field 15 to be able to switch said cholesteric liquid crystal materials 8 to said homeotropic texture, it will be understood by one skilled-in-the-art that the magnitude of said voltage-signal 14 must exceed the threshold voltage for said cholesteric liquid crystal materials 8 thereof.

Furthermore with reference now to FIG. 6, if instead a suitable externally generated high voltage-signal 14 is applied between said electrode-patterning 6a and said electrode-patterning 6b respectively, with both electrode-patternings 6a, 6b being located on the inner-surface of the same said first substrate 4, and with there being simultaneously no additional voltage-signal applied to said second electrode 7 on the inner-surface of said second substrate 5 thereto, then in such case a tangential (i.e. in-plane) electrical-field 16 will be generated within said cholesteric liquid crystal materials 8 with at least a component of the electrical-field vector being substantially aligned in a direction that is parallel (i.e. tangential) with the inner-surfaces of said first and second substrates 4, 5 thereof Moreover, it will be understood by one skilled-in-the-art that said tangential electrical-field 16 will then assist with the relaxation of said cholesteric liquid crystal materials 8 when switching from said homeotropic texture to said focal-conic texture thereto. Furthermore, since said focal-conic texture comprises a plurality of randomly oriented poly-domain regions, then it will be understood by one skilled-in-the-art that said tangential electrical-field is not mandated to be spatially uniform, and more specifically a tangential electrical-field possessing a spatially varying field-strength will enhance and assist the formation of said poly-domain focal-conic texture, thereby increasing the level of light scattering generated by said optical-shutter according to an embodiment of the present invention.

The disclosed invention thereby provides for a voltage-assisted relaxation step that significantly increases the relaxation switching speed of said cholesteric liquid crystal optical-shutter. Specifically, it is disclosed that a suitable perpendicular electrical-field 15 is first used to switch said cholesteric liquid crystal materials 8 to the homeotropic texture, and then a suitable tangential electrical-field 16 is thereafter used to assist in the relaxation (i.e. switching) of said cholesteric liquid crystal materials 8 back to the focal-conic texture thereto.

The externally generated voltage signals may, for example, comprise of square-wave Alternating Current (AC) with frequency typically between 1.0 Hz and 500 Hz, and more preferably with frequency between 20 Hz and 200 Hz, respectively. Moreover, it will be understood by one skilled-in-the-art that it is the Root Mean Squared (RMS) value of the magnitude of the externally generated voltage signals that determines the state to which said cholesteric liquid crystal materials will switch. Specifically, when the RMS value of the magnitude of the voltage-signal is less than the threshold voltage, then the molecular-axes of said cholesteric liquid crystal materials will remain predominantly unperturbed by the resulting electrical-field vector. However, when the RMS value of the magnitude of the voltage-signals exceeds the threshold voltage, then the molecular-axes of said cholesteric liquid crystal materials will in such case align substantially parallel with the resulting electrical-field vector. It will also be understood by one skilled-in-the-art that said externally generated voltage signals may instead comprise of Direct Current (DC) without departing from the inventive ideas disclosed herein.

Furthermore, it will be understood by one skilled-in-the-art that since the disclosed invention provides for a voltage-assisted relaxation switching step from the homeotropic to focal-conic texture, then the pitch of said cholesteric liquid crystal materials 8 may in such case be reduced whilst still maintaining said relaxation switching speed at a high level. This additionally reduces the magnitude of the voltage-signals required to switch said cholesteric liquid crystal materials 8 back to said homeotropic texture thereof and thereby reduces the overall power consumption of said cholesteric liquid crystal optical-shutter according to the present invention.

Moreover, since the disclosed cholesteric liquid crystal optical-shutter according to the present invention is required to be modulated between said first and second optical states at high frequencies of typically 144 Hz when used in applications such as active 3d shutter-glasses, then said cholesteric liquid crystal materials 8 do not require the utilization of a polymer-network or similar additive in order to stabilize said optical states over extended periods of time. This not only provides for an increase in the overall optical transmission of said cholesteric liquid crystal materials when switched to said homeotropic texture (i.e. open), but also increases the lifetime stability of the product as compared to other prior-art technologies.

It will also be known to one skilled-in-the-art that said cholesteric liquid crystal materials 8 can be synthesized, for example, by doping one or more nematic liquid crystal materials with a suitable chiral additive so as to induce a spontaneous helical-twisting structure within said nematic liquid crystal materials in the absence of a voltage-signal or other externally imposed boundary conditions. For example, the MDA-05-4876 nematic liquid crystal material commercially available from Merck KGaA may be mixed together with approximately 5.0% (by weight) of the ZLI-4571 chiral additive, also supplied by Merck KGaA, so as to obtain a suitable cholesteric liquid crystal material. The exact concentration of chiral additive determines the resulting pitch of said cholesteric liquid crystal materials, and furthermore the intrinsic pitch then controls both the spontaneous relaxation switching speed of said cholesteric liquid crystal materials from the homeotropic to focal-conic texture, as well as the magnitude of the voltage-signals required to switch said cholesteric liquid crystal materials back to said homeotropic texture thereto.

A further preferred embodiment of the present invention is that a small concentration of dichroic-dye material may be dissolved into said cholesteric liquid crystal materials 8 in order to absorb at least some of the scattered-light when said cholesteric liquid crystal materials are switched to said focal-conic texture. Specifically, the concentration of said dichroic-dye materials should preferably be in the interval between 0.1% (by weight) and 10% (by weight), and more preferably in the interval between 0.5% (by weight) and 5.0% (by weight), respectively. For example, the S428 black dichroic-dye material supplied by Mitsubishi Chemicals with a concentration of 3.0% (by weight) is suitable for this purpose as a preferred embodiment of the present invention.

Moreover, it will be understood by one skilled-in-the-art that when said cholesteric liquid crystal materials 8 are switched to said homeotropic texture, then the molecular-axes of said dichroic-dye materials will in such case be aligned in a direction substantially perpendicular to the inner-surfaces of said substrates 4, 5 thereof, and furthermore when aligned in such orientation said dichroic-dyes permit light to pass through said cholesteric liquid crystal optical-shutter without the occurrence of a significant level of light absorption. However, if instead said cholesteric liquid crystal materials are switched to said focal-conic texture, then in such case the molecular-axes of said dichroic-dye materials will then be substantially aligned in a direction parallel with the inner-surfaces of said substrates 4, 5 thereof, and furthermore when aligned in such orientation said dichroic-dyes will then strongly absorb light passing though said system. In such way, the overall level of on-screen image-haze can thereby be reduced when viewing time-multiplexed stereoscopic 3d images together with said active 3d shutter-glasses according to the present invention.

Furthermore, it will be understood by one skilled-in-the-art that due to the relatively high molecular weight of typical dichroic-dye materials currently commercially available, the overall viscosity of said cholesteric liquid crystal materials 8 will be increased upon addition of said dichroic-dye materials to said cholesteric liquid crystal materials thereof. This will therefore result in a reduction of the spontaneous relaxation switching speed of said cholesteric liquid crystal materials from the homeotropic to focal-conic texture. However, since the disclosed invention provides for a voltage-assisted relaxation step, then the reduction in the spontaneous relaxation switching speed for said cholesteric liquid crystal materials upon addition of said dichroic-dye materials can be compensated for via utilization of said tangential electrical-field as disclosed herein according to the present invention.

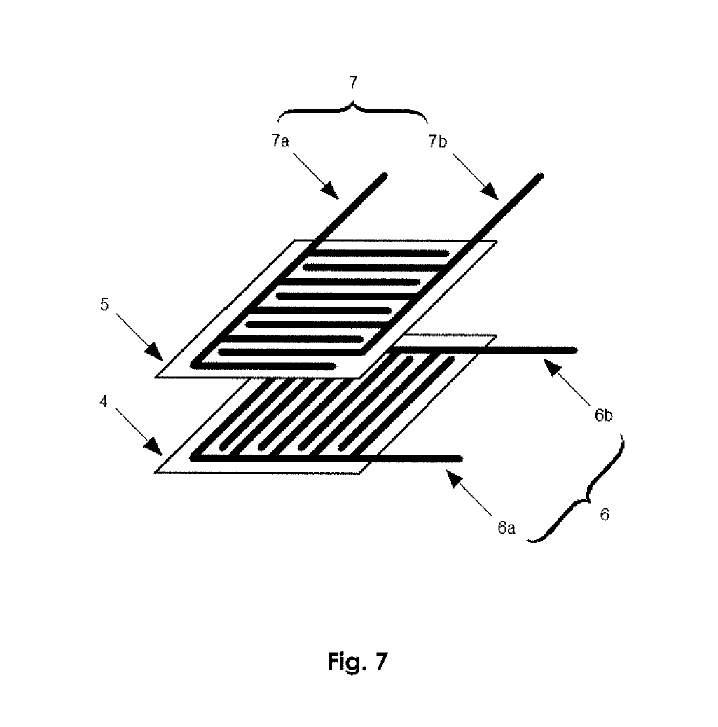

FIG. 7 shows a further preferred embodiment of the present invention where said first electrode 6 on the inner-surface of said first substrate 4 is patterned to form a plurality of individual and mutually parallel electrode-lines, with all odd-numbered electrode-lines preferably being electrically connected together in parallel along a first edge of said first substrate 4 to form a first electrode-patterning 6a, and with all even-numbered electrode-lines preferably being electrically connected together in parallel along a second edge of said first substrate 4 to form a second electrode-patterning 6b, with said first and second electrode-patternings 6a, 6b being formed on the inner-surface of the same said first substrate 4, and with said first and second edges of said first substrate 4 being located on predominantly opposite sides of said first substrate 4 thereto.

Furthermore, said second electrode 7 on the inner-surface of said second substrate 5 is also patterned to form a plurality of individual and mutually parallel electrode-lines, with all odd-numbered electrode-lines preferably being electrically connected together in parallel along a first edge of said second substrate 5 to form a third electrode-patterning 7a, and with all even-numbered electrode-lines preferably being electrically connected together in parallel along a second edge of said second substrate 5 to form a fourth electrode-patterning 7b, with said third and fourth electrode-patternings 7a, 7b being formed on the inner-surface of the same said second substrate 5, and with said first and second edges of said second substrate 5 being located on predominantly opposite sides of said second substrate 5 thereto.

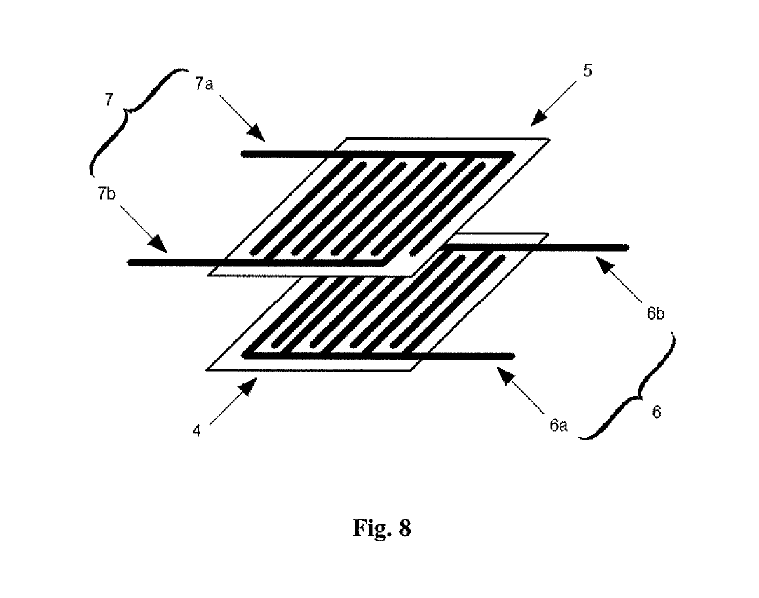

Additionally, a further preferred embodiment of the present invention is that said electrode-lines composing each of said electrode-patternings 6a, 6b on the inner-surface of said first substrate 4 are aligned substantially perpendicular to said electrode-lines composing each of said electrode-patternings 7a, 7b on the inner-surface of said second substrate 5 thereof. Furthermore, it is also disclosed that an alternative preferred embodiment of the present invention is that said electrode-lines composing each of said electrode-patternings 6a, 6b on the inner-surface of said first substrate 4 are instead aligned substantially parallel with said electrode-lines composing each of said electrode-patternings 7a, 7b on the inner-surface of said second substrate 5 thereto as shown in FIG. 8.

In such case, a first voltage-signal (not shown) can then be applied between said electrode-patterning 6a and said electrode-patterning 6b in order to generate a first tangential electrical-field (not shown) in close proximity to the inner-surface of said first substrate 4, and also a second voltage-signal (not shown) can simultaneously be applied between said electrode-patterning 7a and said electrode-patterning 7b in order to create a second tangential electrical-field (not shown) in close proximity to the inner-surface of said second substrate 5 thereof, with said first and second tangential electrical-fields both possessing electrical-field vectors (not shown) that are aligned substantially parallel (i.e. tangential) with the surfaces of said first and second substrates 4, 5 thereof.

It will be understood by one skilled-in-the-art that said first and second tangential electrical-fields in close proximity to the surfaces of said first and second substrates 4, 5 thereof will enhance the relaxation switching speed of said cholesteric liquid crystal materials (not shown) when switching from the homeotropic to focal-conic texture. Said cholesteric liquid crystal materials will therefore undergo a voltage-assisted relaxation switching step, thereby allowing for the design of cholesteric liquid crystal optical-shutters according to the disclosed invention that possess an improved level of switching speed as compared to other prior-art technologies.

It is further disclosed according to the present invention that in order to switch said cholesteric liquid crystal materials to said homeotropic texture, then a suitable voltage-signal (not shown) can be applied between said first electrode 6 comprising of both said electrode-patternings 6a, 6b, and said second electrode 7 comprising of both said electrode-patternings 7a, 7b thereto. In such case, an electrical-field (not shown) will be generated within said cholesteric liquid crystal materials with electrical-field vector aligned substantially perpendicular to the surfaces of said first and second substrates 4, 5 thereof. Moreover, it will be understood by one skilled-in-the-art that the magnitude of said voltage-signal is required to exceed the threshold voltage for said cholesteric liquid crystal materials 8 in order for said voltage-signal to be able to switch said cholesteric liquid crystal materials to said homeotropic texture.

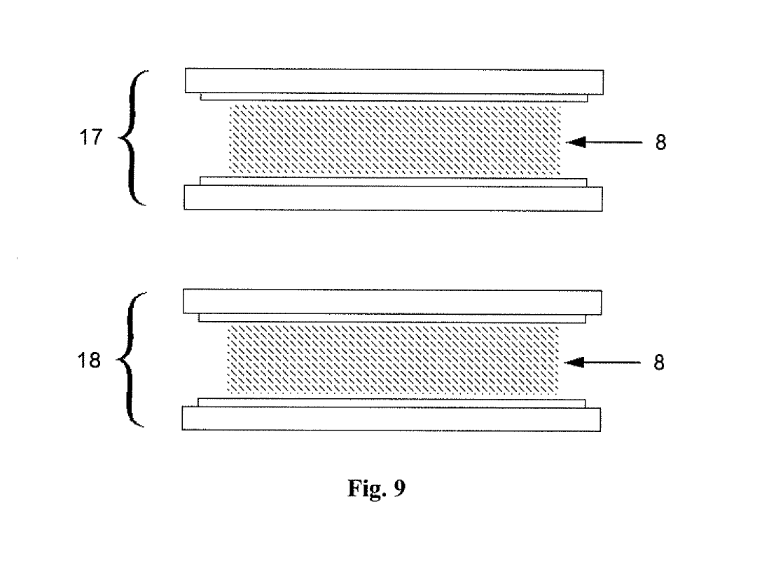

FIG. 9 shows a further preferred embodiment of the present invention. Here, two separate and individual cholesteric liquid crystal optical-shutters 17, 18 each individually of the type disclosed herein according to the present invention are stacked together in series in order to provide for an increased level of optical opacity when said cholesteric liquid crystal materials 8 in each of said cholesteric liquid crystal optical-shutters 17, 18 thereof are simultaneously switched to the focal-conic texture. In such case, this provides for a higher level of optical blocking and hence reduces the overall level of perceived image-haze when viewing time-multiplexed stereoscopic 3d images together with active 3d shutter-glasses of the type disclosed herein according to the present invention.

Whilst preferred embodiments of the present invention have been shown and described herein, various modifications may be made thereto without departing from the inventive idea of the present invention. Accordingly, it is to be understood that the present invention has been described by way of illustration and not limitation.

What is claimed is:

1. Active 3d shutter-glasses for the viewing of time-multiplexed stereoscopic 3d images comprising a first lens and a second lens, with each of said lenses including at least one optical-shutter having a first substrate and a second substrate with cholesteric liquid crystal material being bound in-between said first and second substrates; said at least one optical shutter further including a first electrode on an inner-surface of said first substrate and a second electrode on an inner-surface of said second substrate, wherein said first electrode is patterned to form a plurality of mutually parallel electrode-lines, with all odd-numbered electrode-lines being electrically connected together in parallel to form a first electrode-patterning, and with all even-numbered electrode-lines being electrically connected together in parallel to form a second electrode-patterning;
wherein the active 3d shutter glasses are configured to receive a first externally generated voltage-signal with a magnitude exceeding a threshold-voltage for said cholesteric liquid crystal material applied between said first electrode and said second electrode in order to generate an electrical-field within said cholesteric liquid crystal material with an electrical-field vector being aligned substantially perpendicular to the inner surfaces of said substrates in order to switch said cholesteric liquid crystal material to a homeotropic texture corresponding to a first optical state possessing a high level of optical transmission;
wherein the active 3d shutter glasses are further configured to receive a second externally generated voltage-signal being applied between said first electrode-patterning and said second electrode-patterning of said first electrode in order to generate an in-plane electrical-field within said cholesteric liquid crystal material with an electrical-field vector being aligned substantially parallel with the inner surfaces of said substrates in order to provide for a voltage-assisted relaxation switching step when said cholesteric liquid crystal material switch from said homeotropic texture to the focal-conic texture corresponding to a second optical state thereof, and with said second optical state possessing a relatively low level of optical transmission; and
wherein each said optical-shutter is configured to be modulated between said first and second optical states in synchronization with images generated by an external display system in order to generate a time-multiplexed three dimensional (3d) image.

2. The active 3d shutter-glasses according to claim 1, wherein said odd-numbered electrode-lines are electrically connected together along a first edge of said first substrate, and said even-numbered electrode-lines are electrically connected together along a second edge of said first substrate, with said first and second edges being located on predominantly mutually opposite sides of said first substrate.

3. The active 3d shutter-glasses according to claim 1, wherein each of said electrode-lines of said first and second electrode-patternings have widths between 5 micrometers and 500 micrometers.

4. The active 3d shutter-glasses according to claim 1, wherein each of said electrode-lines of said first and second electrode-patternings have widths between 20 micrometers and 200 micrometers.

5. The active 3d shutter-glasses according to claim 1, wherein each of said electrode-lines of said first and second electrode-patternings are spaced from adjacent electrode lines by a gap between 1.0 micrometer and 200 micrometers.

6. The active 3d shutter-glasses according to claim 1, wherein each of said electrode-lines of said first and second electrode-patternings are spaced from adjacent electrode lines by a gap between 5 micrometers and 50 micrometers.

7. The active 3d shutter-glasses according to claim 1, wherein the length of each of said electrode-lines of said first and second electrode-pattemings is between 5 millimeters and 500 millimeters.

8. The active 3d shutter-glasses according to claim 1, wherein the length of each of said electrode-lines of said first and second electrode-patternings is between 20 millimeters and 50 millimeters.

9. The active 3d shutter-glasses according to claim 1, wherein the distance between said first and second substrates of the at least one optical shutter of each lens is between 2.5 micrometers and 30 micrometers.

10. The active 3d shutter-glasses according to claim 1, wherein the distance between said first and second substrates of the at least one optical shutter of each lens is between 4.0 micrometers and 20 micrometers.

11. The active 3d shutter-glasses according to claim 1, wherein at least one of said first and second electrodes comprises a transparent electrically conducting layer with electrical resistance being between 1.0 ohm per square and 800 ohms per square

12. The active 3d shutter-glasses according to claim 1, wherein at least one of said first and second electrodes comprises a transparent electrically conducting layer with electrical resistance being between 10 ohms per square and 200 ohms per square.

13. The active 3d shutter-glasses according to claim 1, wherein said cholesteric liquid crystal material comprises a dichroic-dye material with concentration between 0.1% (by weight) and 10% (by weight).

14. The active 3d shutter-glasses according to claim 1, wherein said cholesteric liquid crystal material comprises a dichroic-dye material with concentration between 0.5% (by weight) and 5.0% (by weight).

15. The active 3d shutter-glasses according to claim 1, wherein said second electrode is patterned to form a plurality of mutually parallel electrode-lines, with all odd-numbered electrode-lines being electrically connected together in parallel to form a third electrode-patterning, and with all even-numbered electrode-lines being electrically connected together in parallel to form a fourth electrode-patterning.

16. The active 3d shutter-glasses according to claim 15, wherein said electrode-lines of said first and second electrode-patternings are aligned substantially perpendicular to said electrode-lines of said third and fourth electrode-patternings.

17. The active 3d shutter-glasses according to claim 15, wherein said electrode-lines of said first and second electrode-patternings are aligned substantially parallel with said electrode-lines of said third and fourth electrode-patternings.

18. The active 3d shutter-glasses according to claim 1, wherein the at least one optical shutter of at least one of said first and second lenses comprises a stack of at least two optical-shutters each configured according to claim 1.

19. Active 3d shutter-glasses for the viewing of time-multiplexed stereoscopic 3d images, comprising:
a first lens and a second lens, each of said lenses including at least one optical-shutter, the at least one optical shutter including:
a first substrate and a second substrate with cholesteric liquid crystal material being bound in-between said first and second substrates; and
a first electrode on an inner-surface of said first substrate and a second electrode on an inner-surface of said second substrate, wherein said first electrode is patterned to form a plurality of mutually parallel electrode-lines, with all odd-numbered electrode-lines being electrically connected together in parallel to form a first electrode-patterning, and with all even-numbered electrode-lines being electrically connected together in parallel to form a second electrode-patterning.

20. The active 3d shutter-glasses of claim 19 being configured to receive a first externally generated voltage-signal with a magnitude exceeding a threshold-voltage for said cholesteric liquid crystal material applied between said first electrode and said second electrode in order to generate an electrical-field within said cholesteric liquid crystal materials with an electrical-field vector being aligned substantially perpendicular to the inner surfaces of said substrates in order to switch said cholesteric liquid crystal material to a homeotropic texture corresponding to a first optical state possessing a high level of optical transmission.

21. The active 3d shutter-glasses of claim 20 being further configured to receive a second externally generated voltage-signal being applied between said first electrode-patterning and said second electrode-patterning of said first electrode in order to generate an in-plane electrical-field within said cholesteric liquid crystal material with an electrical-field vector being aligned substantially parallel with the inner surfaces of said substrates in order to provide for a voltage-assisted relaxation switching step when said cholesteric liquid crystal material switch from said homeotropic texture to the focal-conic texture corresponding to a second optical state thereof, and with said second optical state possessing a relatively low level of optical transmission.

22. The active 3d shutter-glasses of claim 21 wherein each said optical-shutter is configured to be modulated between said first and second optical states in synchronization with images generated by an external display system in order to generate a time-multiplexed three dimensional (3d) image.
